(19) United States
(12) Patent Application Publication
(10) Pub. No.: US 2012/0013548 A1
(43) Pub. Date: Jan. 19, 2012

(54) Human-Machine Interface System

(75) Inventors: Dave Choi, Marysville, OH (US); Nicholas A. Scheufler, Dublin, OH (US); Ross Cameron Miller, Hilliard, OH (US); Steven M. Feit, Dublin, OH (US)

(73) Assignee: Honda Motor Co., Ltd., Tokyo (JP)

(21) Appl. No.: 12/839,055

(22) Filed: Jul. 19, 2010

(51) Int. Cl. G06F 3/041

(52) U.S. Cl. 345/173

(57) ABSTRACT

A system and method are provided in which an operator/driver of a vehicle may control a number of components within the vehicle via a single human-machine interface. The system may include a computing device, a touch panel with a touch screen located in a center console area of the vehicle near a seat for the operator/driver, and a display device located at a position higher than the touch screen. The operator/driver may select a control presented on the touch screen by touching the control. A display of the touch screen and/or a display of the display device may change in response to the touching of the control. Displays of the touch screen may include current function mode controls in a first layer, logically-grouped current function menu shortcuts in a second layer and HVAC status and control indicators in a third layer.

### BACKGROUND OF THE INVENTION

1. Field of the Invention

A system and method are provided for permitting a human operator of a vehicle to interact with a number of system components within the vehicle. In various embodiments, an operator may obtain a status of a number of system components within the vehicle and may control operation of the system components while safely operating the vehicle.

2. Description of Related Art

Existing systems and methods for providing a human-machine interface (HMI) between a human operator of a vehicle and system components within the vehicle may include a touch panel and hard keys for command input, along with a high-mounted top display for output and menu navigation. In one existing system, the HMI is not designed as a single system. Instead, the existing system includes an HMI for a heating, ventilating and air conditioning (HVAC) system, an HMI for a wireless linking system (for example, a Bluetooth® linking system, Bluetooth is a registered trademark of Bluetooth Sig, Inc. of Bellevue, Wash.), and an HMI for a navigational system. Because the HMIs in an existing system may vary, a user may become confused when switching from one HMI to another HMI and the user may take longer to become comfortable with the HMIs of the existing system.

### SUMMARY OF THE INVENTION

The present invention addresses the shortcomings of the prior art system and methods. In particular, the present invention is directed to a system and method for providing a single human-machine interface (HMI) for an operator/driver of a vehicle to control a number of system components within the vehicle.

Embodiments of the system may include a computing device, which may function as a navigation system, a touch panel including a touch screen, and a display device. The touch panel may be located in a center console area of the vehicle, next to a seat for the operator/driver. The display device may be positioned within a central portion of a dashboard, such that the operator/driver may safely operate the vehicle when viewing a display of the display device.

A display of the touch screen may include a first layer having selectable mode controls, a second layer having logically-grouped current function menu shortcut controls, and a third layer having heat, ventilation and air conditioning (HVAC) status indicators. A display of the display device may include abbreviated status information and current function information. When a navigation unit is actively guiding the vehicle to a destination, the display of the display device may also include turn-by-turn navigation guidance.

Frequently used controls presented on the touch screen may be located closer to the operator/driver than less frequently used controls. More frequently used controls may be presented at a higher position of the touch screen than less frequently used controls. Same controls appearing in multiple displays of the touch screen may be located at a same position of each of the multiple displays.

In some embodiments, the touch panel may include a control knob for selecting an item from a displayed list, inputting one or more alphanumeric characters, as well as for performing other functions. A set of current function controls may be included as hard buttons located close to a proximity of the touch screen or the set of current function controls may be presented within a separate layer on the touch screen. A set of HVAC controls may be included on the touch panel or as a set of hard buttons located close to the proximity of the touch screen.

### BRIEF DESCRIPTION OF THE DRAWINGS

FIG. 1 illustrates a functional block diagram of an exemplary embodiment.

FIG. 2 illustrates components of an exemplary embodiment within a vehicle.

FIG. 3 shows an exemplary layout of a display of a touch screen as well as an exemplary layout of function controls and HVAC controls.

FIG. 4 shows an exemplary layout of a control knob and a number of hard buttons on a touch panel.

FIG. 5 illustrates an exemplary layout of a display of a display device in various embodiments.

FIGS. 6-9, 12, 13, 15, 17, 19 and 22-24 show exemplary displays of a touch screen in various embodiments.

FIGS. 10, 14, 16, 18, 20, 21 and 25 show exemplary displays of a display device in various embodiments.

FIG. 11 illustrates a layout of exemplary mode controls in one embodiment.

### DETAILED DESCRIPTION OF THE PREFERRED EMBODIMENT

### Overview

A system for a vehicle is provided, which includes a single HMI for a user to interact with various components of the system. For example, the system may include a single HMI for interacting with an audio system, a navigation system, an information system, a rear entertainment system, as well as other systems.

In various embodiments, the system may include a first display on a touch screen of a touch panel and a second display on a display device. The touch panel and the touch screen may be located such that an operator, or driver, of the vehicle may easily touch and view the touch screen without being distracted from safely operating the vehicle. The second display on the display device may be located at a position higher than the touch panel, such that the operator may easily view the second display without being distracted from safely operating the vehicle.

The first display may have a number of layers. A first layer may include selectable mode controls for selecting a mode or a source for a current function. A second layer may include current function favorite controls. A third layer may include HVAC status information. Each of the layers may be located at a respective position of the first display. For example, the first layer may be located at a top portion of the first display, the second layer may be located at a portion of the first display below the first layer, and the third layer may be located below the second layer at a bottom portion of the first display. In other embodiments, the layers of the first display may be arranged differently.

The system may receive input from the operator based on the operator selecting the one of the selectable mode controls or one of the current function favorite controls. In some embodiments, the operator may select a control by touching the control with a finger. The system may change the second display in response to the received input from the operator. The second display may be changed based on which one of the selectable mode controls or the current function favorite controls is selected.

In some embodiments, the system may receive a second input based on the operator selecting one of a number of selectable function controls. The selectable function controls may include, but not be limited to, an audio control, a navigational control, an information control, a phone control and a rear entertainment system control. In other embodiments, the selectable function controls may include additional, or a different, selectable function controls. The selectable function controls may be hard buttons located in close proximity to the first display. For example, the selectable function controls may be located in close proximity to a top portion of the first display, or another portion of the first display. In other embodiments, the selectable function controls may be presented at a fourth layer of the first display. The fourth layer may be located at a top portion of the first display, the first layer may be located at a portion of the first display below the fourth layer and above the second layer, the second layer may be located at a portion of the first display below the first layer and above the third layer, and the third layer may be located at a portion of the first display below the second layer at a bottom portion of the first display. Of course, in other embodiments the layers may be arranged at different portions of the first display.

A touch panel may include the first display, a control knob and at least one hardware button for selecting one of the controls displayed on the first display, and for selecting an item from a list displayed on the second display.

Short or quick frequently performed tasks may be performed by using the touch panel. Longer tasks and lists may use the second display as well as the control knob. Frequently used controls presented on the touch screen may be located closer to the operator/driver than less frequently used controls. More frequently used controls may be presented at a higher position of the touch screen than less frequently used controls. Same controls appearing in multiple displays of the touch screen may be located at a same position of each of the multiple displays for consistency and ease of use.

### Exemplary System

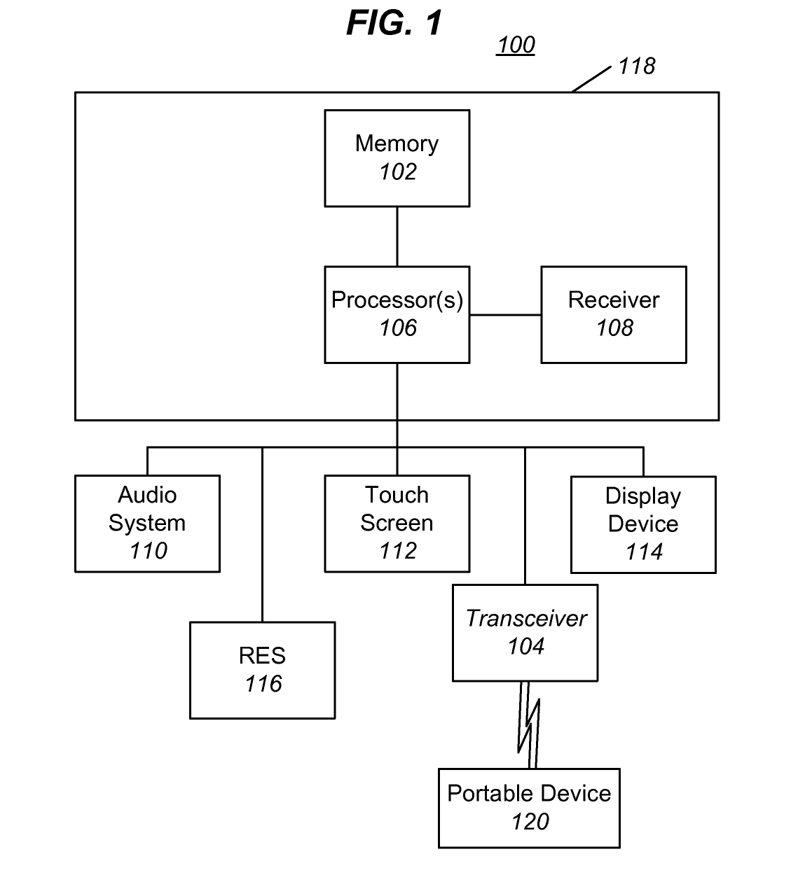

FIG. 1 provides a block diagram of an exemplary system 100, consistent with various embodiments. Exemplary system 100 may include a memory 102, a transceiver 104, a processor 106, a receiver 108, an audio system 110, a touch screen 112, a display device 114 and a rear entertainment system (RES) 116. In some embodiments, memory 102, transceiver 104, processor 106 and receiver 108 may be included in a computing device, which may be a navigation system 118.

Processor 106 may include one or more conventional electronic processors that interpret and execute instructions. Memory 102 may include a random access memory (RAM), a read-only memory (ROM), and/or another type of dynamic or static storage device that stores information and instructions for execution by processor 106. The RAM, or another type of dynamic storage device, may store instructions as well as temporary variables or other intermediate information used during execution of instructions by processor 106. The ROM, or another type of static storage device, may store static information and instructions for processor 106.

Transceiver 104 may communicate with processor 106 via a communication line, and may communicate wirelessly or via a wired connection with a portable device 120. Portable device 120 may include a mobile phone or other communication device. In some embodiments, transceiver 104 may communicate wirelessly with portable device 120 via a Bluetooth® (Bluetooth is a registered trademark of Bluetooth Sig., Inc. of Bellevue, Wash.) protocol. In other embodiments, another wireless protocol may be used. In some embodiments, transceiver 104 may be included as part of navigation unit 118.

Receiver 108 may communicate with processor 106 via the communication line and may receive information from one or more global positioning satellites, or another type of global positioning system.

Audio system 110 may include one or more speakers for playing audio content. Touch screen 112 may include a display screen and a digitizer for displaying output to a user and receiving input from the user based on contact with touch screen 112. Display device 114 may include a display screen for displaying information to the user. RES 116 may be located such that passengers at a rear passenger location of a vehicle may be entertained. RES 116 may include a display screen for displaying video or picture images and one or more speakers located at the rear passenger location of the vehicle.

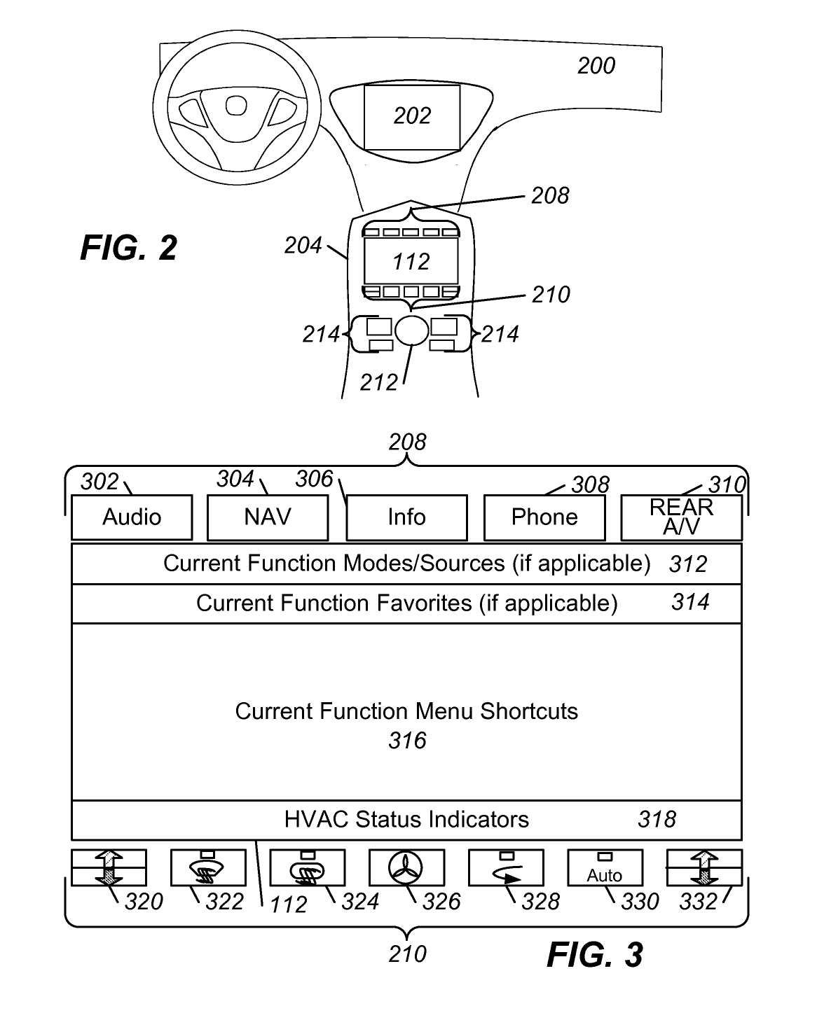

FIG. 2 illustrates positioning of some components of exemplary system 100 within a vehicle. In this embodiment, a dashboard 200 may include a first display screen 202 of a display device, such as display device 114, positioned at a central portion of dashboard 200 such that a user, or an operator/driver, of a vehicle may easily view first display screen 202 without being distracted from operating the vehicle. First display screen 202 may be located close to eye level such that the operator/driver of the vehicle may view first display screen 202 while being able to peripherally view a roadway ahead. In other embodiments, first display screen 202 may be positioned at another location within the vehicle.

A touch panel 204 may be located next to the operator/driver of the vehicle and may include touch screen 112 positioned to be easily viewable by the operator/driver, such that the operator/driver is not distracted while operating the vehicle. In some embodiments, touch panel 204 may be located in a center console area next to the operator/driver. Touch panel 204 may include selectable function controls 208, which may include a first set of hard buttons positioned above touch screen 112, and HVAC controls 210, which may include a second set of hard buttons located below touch screen 112. In other embodiments, selectable function controls 208 and HVAC controls 210 may be positioned at other locations. Touch panel 204 may further include a control knob 212 as well as other controls 214, to be discussed further below.

FIG. 3 illustrates selectable function controls 208, touch screen 112 and HVAC controls 210 of FIG. 2 in greater detail. In FIG. 3, exemplary selectable function controls 208 may include an audio function control 302, a navigation function control 304, an information function control 306, a phone function control 308, and a rear audio/video control 310. In other embodiments, selectable function controls 208 may be arranged in a different order, may include additional or fewer selectable function controls, or may include a completely different set of selectable function controls.

An exemplary display screen of touch screen 112 (hereinafter, referred to as a second display screen, in order to distinguish the second display screen from first display screen 202), shown in FIG. 3, may include a number of layers. A first layer of the second display screen may include a number of current function mode, or source, controls 312, if applicable to a current function. A second layer of the second display screen may include a number of current function favorites 314, if applicable to the current function. A third layer of the second display screen may include a number of logically grouped current function menu shortcuts 316. A fourth layer of the second display screen may include a number of HVAC controls and status indicators 318. The second display screen is only exemplary. In other embodiments, the second display screen may have another arrangement of the layers. For example, an order of the layers on the display screen may differ from the exemplary second display screen described above. Further, a number of the layers may differ in other embodiments and some or all of the layers of the second display screen may differ from the layers discussed with respect to FIG. 3.

HVAC controls 210 may include a driver side temperature control 320, a front defroster control 322, a rear defroster control 324, a fan control 326, a recycled air control 328, an automatic mode HVAC control 330 (for maintaining at least a portion of a passenger compartment of the vehicle at a set temperature), and a passenger side temperature control 332. Front defroster control 322, rear defroster control 324, recycled air control 328 and automatic mode HVAC control 330 may each include a respective status indicator indicating whether the respective control is on or off. HVAC controls 210 shown in FIG. 3 are exemplary. In other embodiments, HVAC controls 210 may be arranged in a different order and may include more or fewer HVAC controls than as shown in FIG. 3.

In an alternate embodiment, selectable function controls 208 may be presented as a fifth layer of the second display screen of touch screen 112. In one variation of the alternate embodiment, the fifth layer may be located at a top portion of the second display screen. However, in other variations of the alternate embodiment, the fifth layer may be located at other positions of the second display screen.

Similarly, in a second alternate embodiment, HVAC controls 210 may be absent and HVAC controls and status indicators 318 may perform a same set of functions as HVAC controls 210 would have performed. In variations of the second alternate embodiment, the fourth layer, which includes HVAC controls and status indicators 318 may be located at a different portion of the second display screen of touch screen 112. For example, the fourth layer may be located at a top portion of the second display, or at another portion of the second display.

In a third alternate embodiment, HVAC controls and status indicators 318 may be absent and HVAC controls 210 may perform a same set of functions as HVAC controls and status indicators 318.

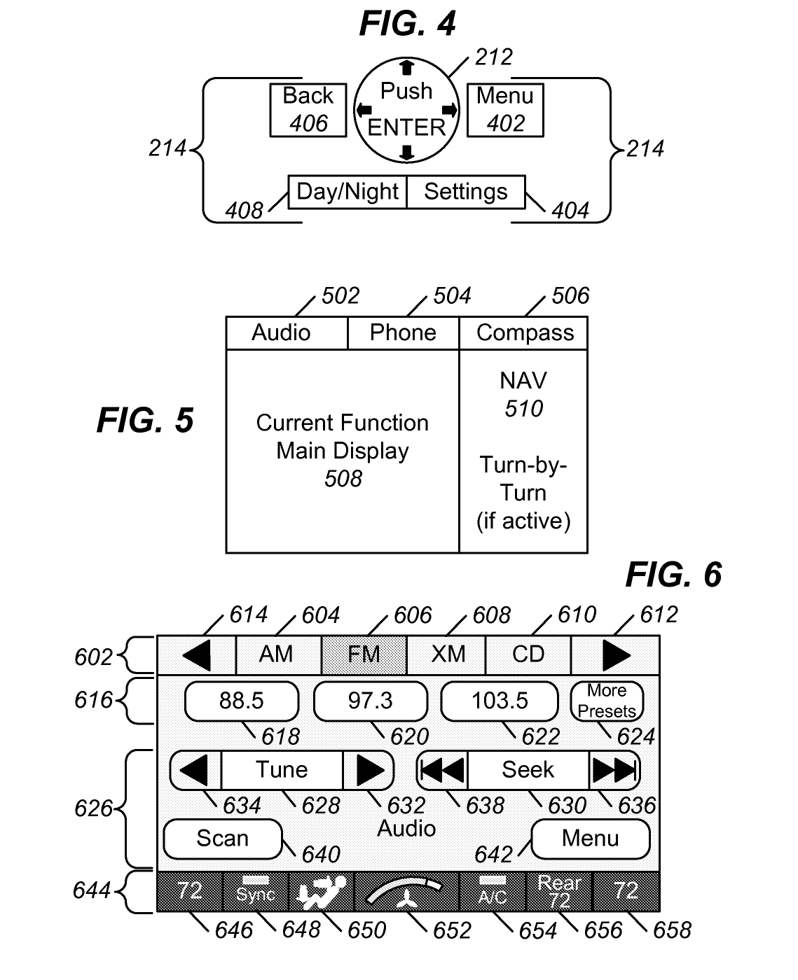

FIG. 4 shows an exemplary detailed view of control knob 212 and other controls 214 of FIG. 2. Control knob 212 may be pushed in at least one of four directions, as indicated by arrows in FIG. 4. Control knob 212 may be used by a user, such as an operator/driver of a vehicle, to indicate a selection from among a number of items of a displayed list. Control knob 212 may also be used to page up (by pushing control knob 212 in an upward direction) and to page down (by pushing control knob 212 in a downward direction). Further, control knob 212 may be used to continuously page up (by pushing and holding control knob 212 in the upward direction) and to continuously page down (by pushing and holding control knob 212 in the downward direction). Control knob 212 will be discussed in more detail below.

Menu button 402, when pushed, may cause a menu to be displayed on the second display screen. Back button 406, when pushed, may cause an immediately preceding display screen to be displayed. Settings button 404 may cause a settings menu to be displayed, from which a user may set a number of settings, including, but not limited to, phone settings, information settings, rear audio/video settings, display settings, and clock settings. Day/night button 408 may cause settings for first display screen 202 and the second display screen to toggle between a daytime setting and a nighttime setting. In some embodiments, the daytime setting may configure the display screens to display items in a first set of colors and a first set of fonts and the nighttime setting may configure the display screens to display the items in a second set of colors and a second set of fonts.

FIG. 5 illustrates an exemplary layout of first display screen 202. With reference to FIG. 5, the exemplary layout may include abbreviated status information, such as, for example, an audio status 502, a phone status 504 and a compass indicator 506 at a top portion of the first display screen 202. In other embodiments, audio status 502, phone status 504 and compass indicator 506 may be positioned at a different location of first display screen 202 such as, for example, a bottom portion of first display screen 202 or another portion of first display screen 202. The exemplary layout of first display screen 202 may further include current function information within a current function main display 508 and, if a route is programmed, or set, and navigation system 118 is active, a turn-by-turn display 510 may guide a vehicle to a destination.

In some embodiments, audio status 502 may be displayed as one of AM, FM, XM or other satellite radio indicator, CD, iPod® (iPod is a registered trademark of Apple Inc. of Cupertino, Calif.) or other audio device indicator, AUX (auxiliary), Bluetooth® audio or other short-range wireless audio indicator, and DVD (digital video disc). In other embodiments, audio status 502 may be displayed as one of a subset of the above-mentioned audio indicators or may include additional or different audio indicators.

FIG. 6 illustrates an exemplary display of the second display screen of touch screen 112. The exemplary display may be presented when a current function is audio. A first layer 602 of the display corresponds to current function mode, or source, controls 312 (FIG. 3). As shown in FIG. 6, first layer 602 may include an AM control 604, an FM control 606, an XM (or other satellite radio) control 608 and a CD (compact disc) control 610. To view other controls of first layer 602, a user may select a next control 612 or a previous control 614. In FIG. 6, FM control 606 is highlighted to indicate that the audio function is operating in FM mode. In other embodiments, other visual methods may be employed to indicate a current operating mode including, but not limited to, blinking the control corresponding to the current operating node, changing a transparency of the control, changing a font included within the control, or by other visual methods.

A second layer 616 may correspond to current function favorites 314 (FIG. 3). As shown in FIG. 6, while operating in the FM mode, second layer 616 may include a number of station presets 618, 620, 622. Each of station presets 618, 620, 622 may include a station indication, such as, for example, 88.5, 97.3, 103.5, or another station indication. To view more station presets, a user may select more presets 624.

A third layer 626 may correspond to logically grouped current function menu shortcuts 316 (FIG. 3). In FIG. 6, third layer 626 may include a tune control 628, a seek control 630, a scan control 640 and a menu control 642. A user may tune to a given station by selecting either a tune higher control 632 or a tune lower control 634. The user may seek and tune to another station by selecting either a seek higher control 636 or a seek lower control 638. The user may respectively tune to preset stations for predetermined time intervals by selecting scan control 640. The user may stop scanning by selecting scan control 640 again. The user may select menu control 642 to cause a menu to be displayed, from which the user may make a selection. The menu may be displayed either on the second display of touch screen 112 or on the first display, depending on system and task goals.

In FIG. 6, a fourth layer 644 may correspond to HVAC controls and status indicators 318 (FIG. 3). A first one of HVAC controls and status indicators 646 may indicate a temperature of a driver's side of a passenger compartment. A second one of HVAC controls and status indicators 648 may indicate whether a heating/cooling temperature setting of the driver's side of the passenger compartment is synchronized with a heating/cooling temperature setting of a passenger's side of the passenger compartment. A third one of HVAC controls and status indicators 650 may indicate whether air is being circulated via one or more heating events and/or one or more cooling vents. A fourth one of HVAC controls and status indicators 652 may provide a speed indication with respect to a heating/cooling fan. A fifth one of HVAC controls and status indicators 654 may indicate whether air conditioning is on or off. A sixth one of HVAC controls and status indicators 656 may indicate a temperature setting of a rear passenger portion of the passenger compartment. A seventh one of HVAC controls and status indicators 658 may indicate a temperature setting of a passenger's side of the passenger compartment. In other embodiments, some or all of the HVAC indicators may be different than the HVAC indicators shown in FIG. 6. Further, in other embodiments, more or fewer HVAC indicators may be presented on the second display screen.

In other embodiments, layers 602, 616, 626, 644 may be arranged in a different order of the second display screen than as shown in FIG. 6. Further, more or fewer layers may be presented on the second display screen in other embodiments.

The above-mentioned HVAC controls and status indicators may function as HVAC controls as well as HVAC indicators. For example, touching an upper portion of HVAC control and status indicator 646 may increase a temperature setting and touching a lower portion of HVAC control and status indicator 646 may decrease a temperature setting, touching HVAC control and status indicator 652 may increase or decrease a speed of a fan, etc.

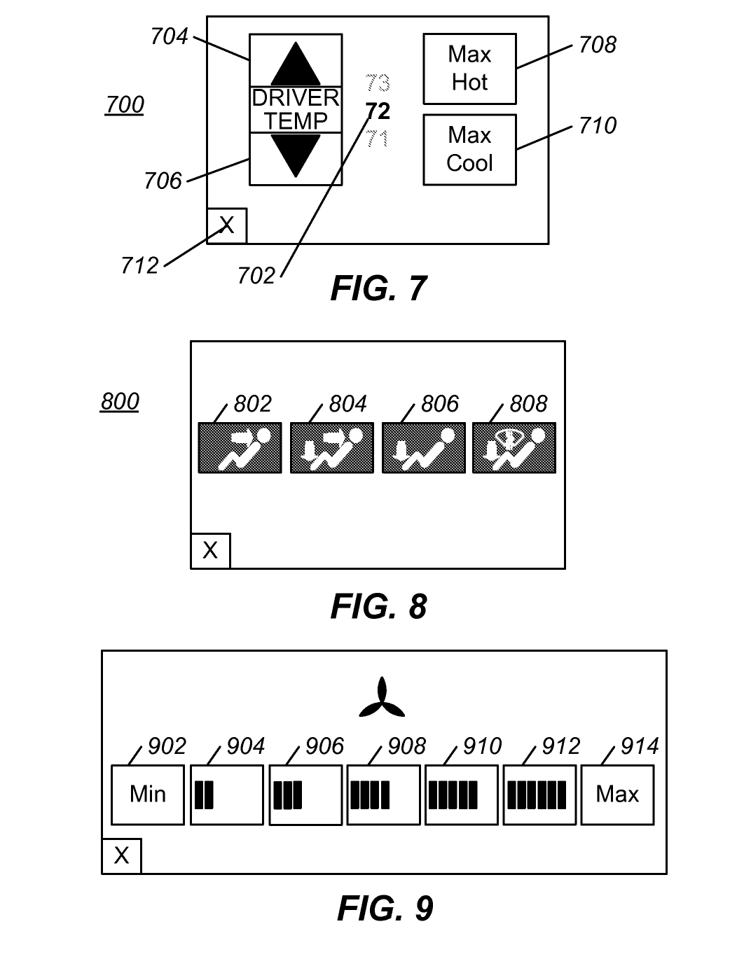

In some embodiments, touching at least some of HVAC control and status indicators may cause a pop-up display screen to be displayed on the second display screen. FIG. 7 illustrates an exemplary pop-up display screen 700 which may be displayed when HVAC control and status indicator 646 is touched. Pop up display screen 700 may display a current temperature setting 702. The temperature setting may be increased by touching increase control 704 and may be decreased by touching decrease control 706. Further, the temperature setting may be set to a maximum heat setting by touching a max hot control 708 and may be set to a maximum air conditioning setting by touching a max cool control 710. Touching close control 712 may cause pop-up display screen 700 to close.

FIG. 8 illustrates an exemplary pop-up display screen 800 which may be displayed when HVAC control and status indicator 650 is touched. Pop-up display screen 800 may display a vent control 802, a heating and vent control 804, a heating control 806 and a heating and defroster control 808. Touching a vent control 802 may open one or more vents to permit air to flow out of the one or more vents. Touching heating and vent control 804 may open one or more vents to permit it to flow out of the one or more events and may permit air to flow from one or more heating vents. Touching heating control 806 may permit air to flow from one or more heating vents. Touching heating and defroster control 880 may cause here to flow from one or more heating vents and from one or more defroster vents.

FIG. 9 illustrates an exemplary pop-up display screen 900 which may be displayed when HVAC control and status indicator 652 is touched. Pop-up display screen 900 may display a number of fan speed controls 902, 904, 906, 980, 910, 912 and 914. Touching fan speed control 902 may cause a fan to rotate at a minimum fan speed. Touching each respective fan speed control 904, 906, 908, 910 and 912 may cause the skin to rotate at successively higher fan speeds. Touching fan speed control 914 may cause the fan to rotate at a maximum speed.

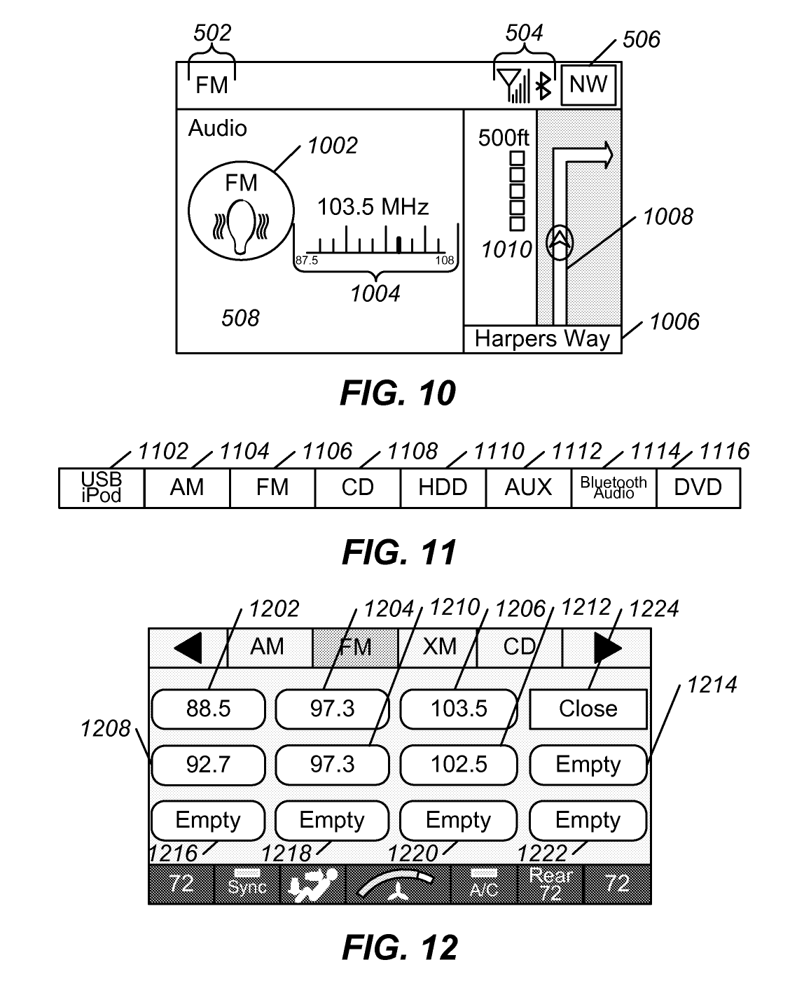

FIG. 10 illustrates an exemplary screen which may be presented on first display screen 202 when operating in an audio function and in an FM mode. In FIG. 10 audio status 502 may indicate that a current mode is FM mode, phone status 504 may indicate a strength of a signal to a wireless phone network and a presence of a short-range wireless signal to a mobile communication device within a vehicle. In some embodiments, the short-range wireless signal may be a Bluetooth® signal. In other embodiments the short-range wireless signal may be a different type of short-range wireless signal. Compass indicator 506 may indicate a compass heading of a current direction of travel of the vehicle. In FIG. 10, compass indicator 506 indicates that the current direction of travel is NW (northwest).

Current function main display 508 of FIG. 10 may clearly indicate a current mode by displaying a mode indicator 1002. In this example, the current mode is FM and current function main display 508 may include a station indicator 1004, which may provide an indication of a current FM station to which the audio function is tuned. If navigation system 118 (FIG. 1) is active and currently guiding the vehicle to a destination, a portion of first display screen 202 may present turn-by-turn display 510 to guide the vehicle to the destination. Turn-by-turn display 510, as shown in FIG. 10, may present a street name indication 1006 of a name of a street to which the vehicle is directed to turn, a representation of a current road upon which the vehicle is traveling along with a next turn street 1008, and a distance indicator 1010 indicating a distance from a current location of the vehicle to the next turn street.

FIG. 11 lists a number of current function mode, or source, controls in one embodiment. The current function mode, or source, controls may include a USB/iPod® control 1102, an AM control 1104, an FM control 1106, a CD control 1108, a hard disk drive (HDD) control 1110, an auxiliary (AUX) control 1112, a Bluetooth® audio control 1114, and a DVD control 1116. In another embodiment, current function mode, or source, controls may further include a satellite radio control, such as an XM control, or another satellite radio control.

The above current function mode, or source, controls may correspond to first layer 602 of FIG. 6. As shown in FIG. 6, first layer 602 may not present all of the current function mode, or source, controls simultaneously. That is, only a predetermined number of the current function mode, or source, controls may be displayed at one time. Selecting either select next control 612 or select previous control 614 may cause a predetermined number of others of the current function mode, or source, controls to be displayed at one time. The above mentioned current function mode, or source, controls may be associated with an audio function. In other embodiments, other current function mode, or source controls, may be associated with a different function.

Referring back to FIG. 6, upon selecting select more presets 624, the second display screen of touch screen 112 may be presented as shown in FIG. 12. As shown, station presets 1202-1222 may be displayed. If particular presets have not yet been set, the particular presets may be displayed with an indication of “Empty” or another indication. In FIG. 12, station presets 1214-1222 are displayed with an indication of “Empty”. To return to a previous display screen, such as, for example, one shown in FIG. 6 or a different display screen, a user may select a close control 1224.

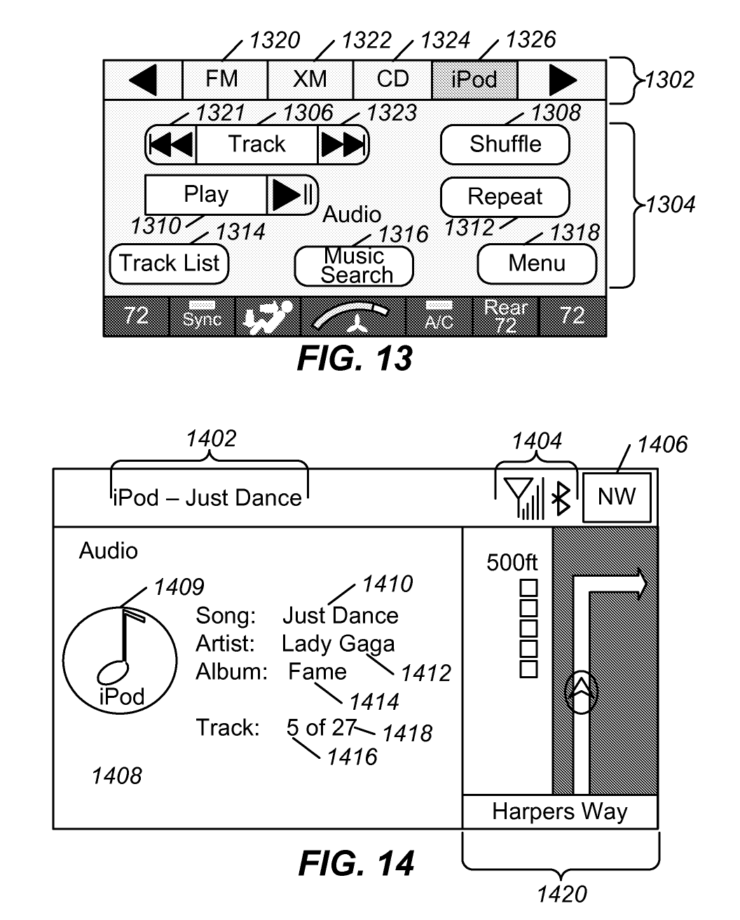

FIG. 13 illustrates an exemplary display of the second display screen of touch screen 112 (FIG. 2). The exemplary display of FIG. 13 may include a first layer 1302, corresponding to current function mode, or source, controls 312 (FIG. 3) and a second layer 1304, corresponding to logically grouped current function menu shortcuts 316 (FIG. 3). As shown in FIG. 13, first layer 1002 may include an FM control 1320, an XM (or other satellite radio) control 1322, a CD control 1324 and a music player control 1326. In FIG. 13, audio player control 1326 controls an iPod® and may be labeled iPod®. However, in other embodiments, audio player control 1326 may control another player device, such as, for example, a USB drive, an MP3 player, or other audio player device, and may be labeled accordingly.

FM control 1320, XM control 1322 and CD control 1324 correspond, respectively, to FM control 606, XM control 608 and CD control 610 of FIG. 6. Selection of audio player control 1326 indicates that an audio player device, such as, for example, an iPod® or other audio player device, is a source of audio input to the audio function. In the exemplary display of FIG. 13, audio player control 1326 may be highlighted to visually indicate that an audio player corresponding to audio player control 1326 is the source of audio input. In other embodiments, other methods may be used to visually indicate a selection of one of controls 1320, 1322, 1324, 1326.

Second layer 1304 may include a track control 1306, a shuffle control 1308, a play control 1310, a repeat control 1312, a track list control 1314, a music search control 1316 and a menu control 1318.

Track control 1306 may include a track next control 1323 and a track previous control 1321. Selection of track next control 1323 may cause a current playing audio item to advance to a next audio item. Selection of track previous control 1321 may cause a previous audio item to become the current playing audio item. Selection of shuffle control 1308 may cause an order of playing audio items of a playlist to be somewhat randomized or shuffled. Selection of shuffle control 1308 may toggle between playing the audio items in a particular order and playing the audio items in a shuffled order. Selection of play control 1310 may toggle a playing state of a currently playing audio item between playing and paused. Selection of repeat control 1312 may cause a current audio item or a current playlist of audio items to repeat after completion. Selection of track list 1314 may cause a list of audio items from a group of tracks to be displayed. Selection of music search control 1316 may cause a display screen to be presented, from which a user may enter one or more desired criteria for a desired audio item. The one or more desired criteria may include an audio item name (i.e., a name of a song), a name of an artist or group, a type of genre, or other criteria. Selection of menu control 1318 may cause a menu to be displayed, from which the user may make a selection. In some embodiments, when a menu control is presented on various display screens of touch screen 112, the menu control may be located in a same position, such that a user would understand to look for the menu control at the same position from among the various display screens.

FIG. 14 illustrates an exemplary display, which may be presented on first display screen 202 when an audio item, provided by an iPod®, is currently playing. In the exemplary display, an audio status 1402 may indicate a source of audio, in this example, an iPod®, and a name of a currently playing audio item, “Just Dance”. A phone status 1404 may provide an indication of a strength of a signal from a wireless telephone network and a presence, or absence, of a short-range wireless signal to a communication device, such as, for example, a mobile phone or other communication device. In other embodiments, phone status 1404 may provide an indication of a strength of a battery in addition to, or instead of, an indication of a strength of the signal from a wireless telephone network. Phone status 1404 of FIG. 14 indicates a strong signal strength from a wireless telephone network and a presence of a short-range wireless signal. A compass indicator 1406 may indicate a direction of travel of a vehicle, such as, for example, northwest (NW), as shown in FIG. 14. A current function main display 1408 may clearly indicate a current mode by displaying a mode indicator 1409, which in this example indicates that a current mode is iPod® (that is, an iPod® is a source of audio). Other information may also be displayed in current function main display 1408, such as, for example, a name of a song 1410, a name of an artist 1412, a name of an album 1414, a current track number 1416 and a total number of tracks 1418.

If navigation unit 118 is actively guiding the vehicle to a destination, then turn-by-turn directions 1420 may be presented in a portion of first display screen 202, as previously discussed.

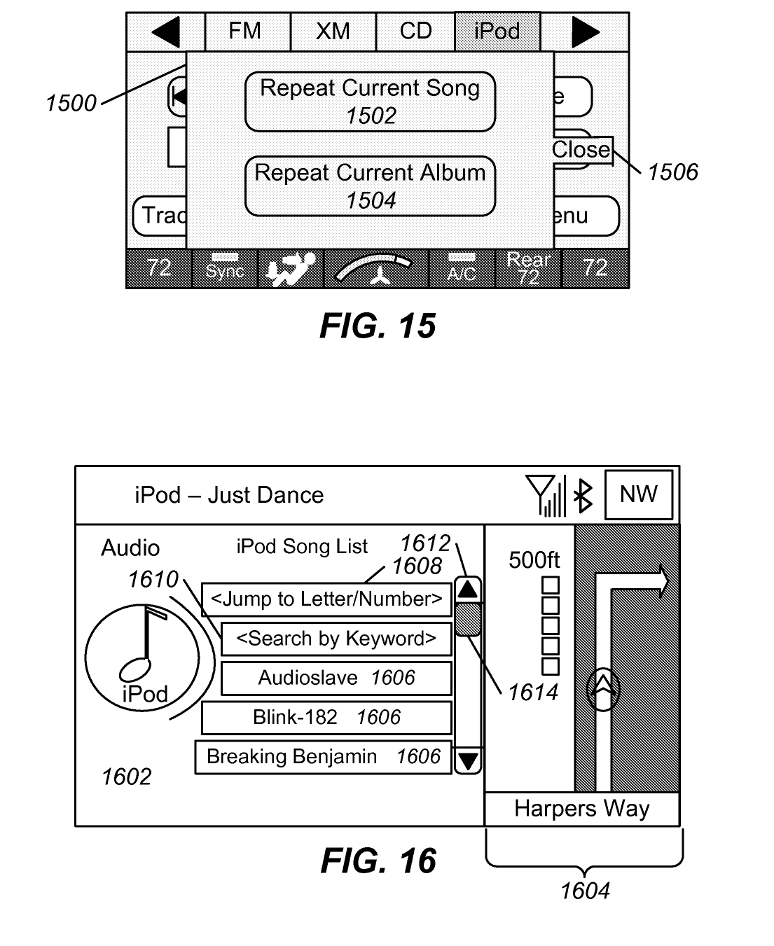

With reference to FIG. 13, FIG. 15 illustrates an exemplary display of touch screen 112 after repeat control 1312 is selected. As shown in FIG. 15, a popup menu 1500 may appear, from which a user may select a repeat current song control 1502, a repeat current album control 1504 or a close control 1506. When repeat current song control 1502 is selected, a currently playing song may be repeated upon completion. When repeat current album control 1504 is selected, after a currently playing album completes playing, the currently playing album may repeat the playing of songs of the album. When close control 1506 is selected, popup menu 1500 may be closed.

With reference to FIG. 13, FIG. 16 illustrates an exemplary display of first display screen 202 after music search control 1316 is selected. The exemplary display may include a current function main display 1602 and turn-by turn guidance 1604 (if navigation unit 118 is currently active and guiding the vehicle to a destination). Current function main display 1602 may include a list of songs or audio items 1606 from which the user may select, a jump control 1608 and a keyword search control 1610.

One of audio items 1606 may be selected by using control knob 212. For example, a current selection from among audio items 1606, jump control 1608 and keyword search control 1610 may be visually indicated by highlighting or blinking a corresponding control, or via other visual methods. A current selection from a list may be moved upward or downward within the list by using control knob 212 and pushing on an upper portion or a lower portion, respectively, of control knob 212. Selecting one of audio items 1606 may cause the selected audio item to be played. Because a number of audio items 1606 may be larger than that which can be displayed at one time, current function main display 1602 may include a scroll control 1612 for scrolling audio items 1606 up or down. As shown in FIG. 16, scroll control 1612 may include a slider on which a control item 1614 may be slid in an upward or downward direction to cause a corresponding scrolling movement of audio items 1606. In other embodiments, another type of scroll control may be employed.

When the current selection is one of audio items 1606, jump control 1608, or keyword search control 1610, the current selection may become scroll control 1612 by the user pushing on a right-side of control knob 212. The user may then scroll up or down by pushing on corresponding portions of the control knob 212. Similarly, when the current selection is scroll control 1612, the current selection may become one of audio items 1606, jump control 1608, or keyword search control 1610 by the user pushing on a left side of control knob 212.

After selection of jump control 1608, a user may be prompted to enter a letter, upon which audio items 1606 may be scrolled until a first audio item beginning with the entered letter is displayed in a top position of displayed audio items 1606. Control knob 212 may be used to enter the letter. Entering a letter will be discussed in more detail below.

After selection of keyword search control 1610, the user may be prompted to enter a keyword. Control knob 212 may be used to enter the keyword. Entering a keyword will be discussed in more detail below.

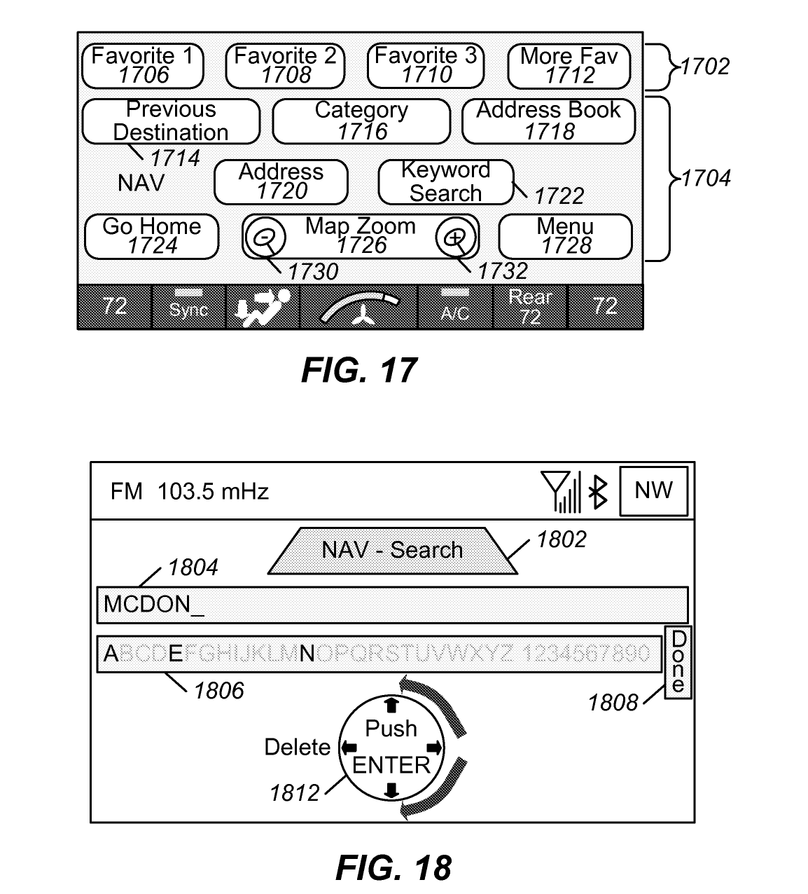

With reference to FIG. 3, FIG. 17 illustrates an exemplary navigation display, which may be presented on touch screen 112 when a navigation unit 118 is not actively guiding a vehicle to a destination. The exemplary navigation display may include a first layer 1702 corresponding to current function favorites 314, and a second layer 1704 corresponding to logically grouped current function menu shortcuts 316.

First layer 1702 may include favorites controls 1706, 1708, 1710 and more favorites control 1712 at a top portion of touch screen 112. Selection of any of favorite controls 1706, 1708, 1710 may cause a screen associated with the selected favorite control to be displayed, or may cause a particular function associated with the selected favorite control to be performed. Selection of more favorite control 1702 may cause a number of favorites controls to be displayed on touch screen 112 in a manner similar to the display of station presets illustrated in FIG. 12.

Second layer 1704 may include a previous destination control 1714, a category control 1716, an address book control 1718, an address control 1720, a keyword search 1722, a go home control 1724, a map zoom control 1726 and a menu control 1728. Selection of previous destination control 1714 may cause a navigation unit 118 to calculate a route from a current location to a previously set destination. Selection of category control 1716 may cause a menu of categories for points of interest to be displayed, from which a user may select a category, such as, for example, restaurants, fueling stations, hospitals, etc. Selection of address book control 1718 may cause an address book to be displayed, through which the user may search for an entry, modify an entry, delete an entry, or add an entry. Selection of address control 1720 may cause a display to be presented prompting the user to enter an address. Selection of keyword search control 1722 may cause a display to be presented prompting the user to enter a keyword, as described in more detail below. Selection of a map zoom control 1726 may cause a displayed map to be zoomed-in (by selecting a zoom-in control 1732) or zoomed-out (by selecting a zoom-out control 1730). Selection of menu control 1728 may cause a menu to be displayed on touch screen 112.

FIG. 18 illustrates an exemplary display which may be presented on first display screen 202 after a user selects keyword search 1722 (FIG. 17). The exemplary display may include a function indicator 1802 indicating a current function, which, in this example, is a search function by navigation unit 118. Upon receiving a keyword, navigation unit 118 may search a database of points-of-interest for a point-of-interest having a name matching the keyword. In the example shown in FIG. 18, a user entered the letters “M” “C” “D” “O” and “N”, which may appear in window 1804. Letters or numbers may be entered by selecting a desired letter or a desired number from window 1806 by rotating control knob 212. The user may then push control knob 212 to enter the selected letter or number into window 1804. A currently selected letter or number from window 1804 may be visually indicated by color, shading, blinking, or other visual method.

In the embodiment shown in FIG. 18, as each letter or number is entered, possible next letters or numbers may be visually indicated in window 1806 and all other letters or numbers in window 1806 may be grayed out, such that grayed-out numbers or letters cannot be entered. In other embodiments, no numbers or letters of window 1806 may be grayed-out. After the user enters all desired letters and/or numbers, the user may rotate control knob 212 to select done control 1808 to indicate completion of entering of the keyword. In some embodiments, control knob 212 may be represented by a graphic 1812 on first display screen 202.

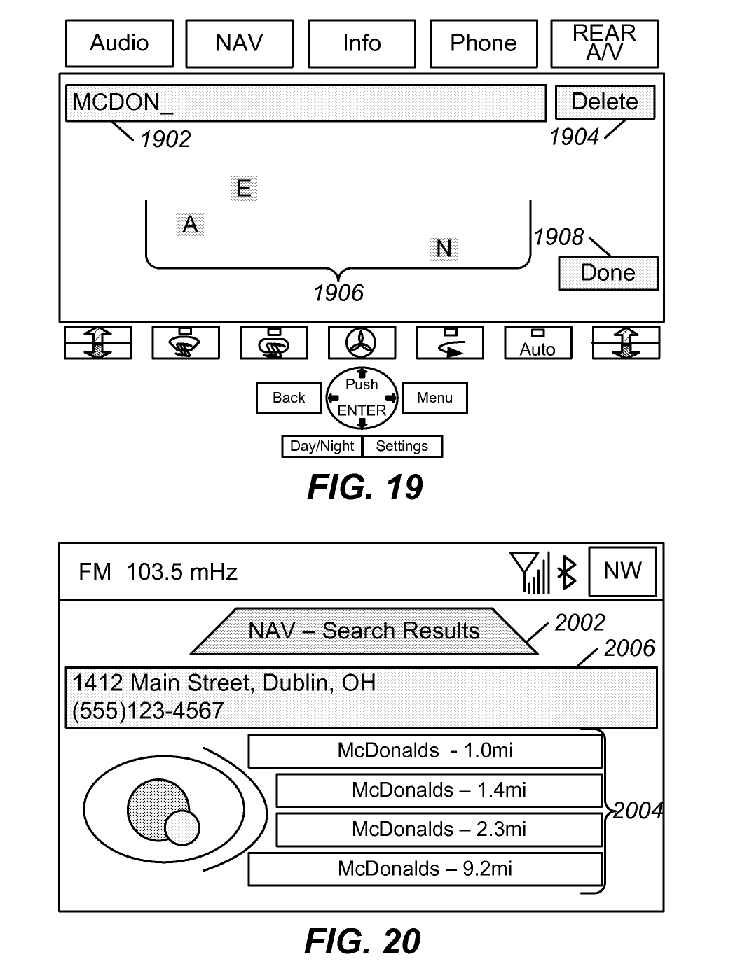

In some embodiments, while the exemplary display of FIG. 18 may be presented on a first display screen 202, a keyboard may be presented on touch screen 112. The user may select desired letters or numbers by touching a corresponding displayed key of the keyboard presented on touch screen 112, as shown in FIG. 19, or by rotating and pushing control knob 212, as described above.

FIG. 19 illustrates an exemplary method by which a displayed keyboard may be used to enter desired letters or numbers via touch screen 112. As in the example of FIG. 18, the user has already entered the letters “M” “C” “D” “O” and “N”, which may appear in window 1902. Below window 1902, a qwerty keyboard 1906 may be displayed initially. As the user enters letters or numbers and at least a partial match is found with respect to the already entered letters or numbers, only those letters and those numbers that, at least partially, match an item are shown. For example, suppose the user was entering the keyword “MCDONALDS”. After entering each letter “M” “C” “D” “O” and “N” by touching the respective keys of the displayed qwerty keyboard, only a next letter or next number which matches an item in a point-of-interest database may be displayed. As can be seen in FIG. 19, only “A” may be displayed to match an item “MCDONALDS” in the point-of-interest database, as well as “E” and “N” to partially match other items (“MCDONE . . . ” or “MCDONN . . . ”) in the point-of-interest database. The user may select done control 1908 to complete entry of the keyword.

In another embodiment, all letters and numbers of qwerty keyboard 1906 may be displayed. However, as the user enters letters and/or numbers, letters and numbers of qwerty keyboard 1906 that, when entered, do not result in a partial match in a database, such as the-point-of-interest database or another database, may be grayed-out such that the user may not be permitted to select the grayed-out letters and numbers.

With reference to FIG. 13, entering a keyword after selecting music search control 1316 may be performed in a same manner as was discussed with respect to FIG. 18. For example, a user may enter each letter or number by using control knob 212 to select each desired letter or number the user wishes to enter, in a same manner as previously described with respect to FIG. 18. Similarly, the user may enter each letter or number by touching a letter or number on a displayed qwerty keyboard as previously described with respect to FIG. 19.

FIG. 20 shows an exemplary display of first display screen 202 after the keyword “MCDONALDS” is entered via a display screen as shown in either of FIG. 18 or 19. The display of FIG. 20 may include a function indicator 2002 indicating a function associated with the exemplary display. In this example, function indicator 2002 may indicate that results of a navigation search are displayed. The exemplary display may include one or more search result matches 2004 and respective distances from a current location. In some embodiments, ones of the one or more search result matches 2004 that are closest to the current location may be displayed before others of the one or more search result matches. Initially, an address and a telephone number of a closest one of the one or more search result matches may be displayed in an information window 2006. The user may select another of the one or more search result matches 2004 by rotating and pushing control knob 212, as previously discussed, which may result in a corresponding address and a corresponding telephone number being displayed in information window 2006.

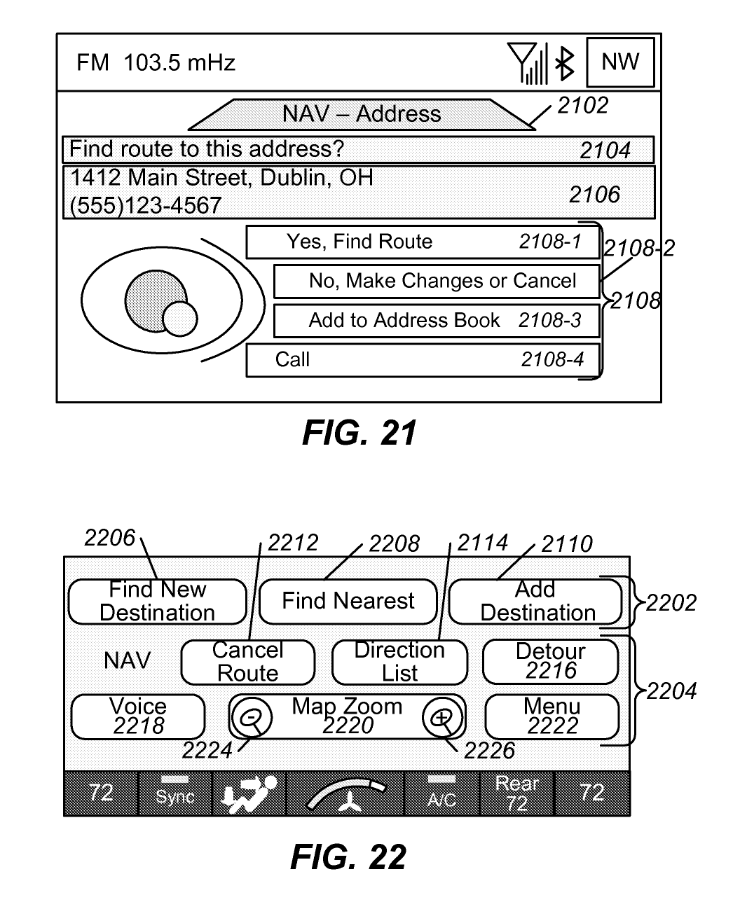

With respect to a selected one of the one or more search result matches 2004, the user may be prompted regarding whether navigation unit 118 is to find a route to an address displayed in information window 2006. FIG. 21 illustrates an exemplary display of first display screen 202, which prompts the user regarding whether navigation unit 118 is to find a route to an address.

In FIG. 21, a function indicator 2102 indicates that the display is associated with navigation unit 118 finding a route to an address. A prompt may be displayed in window 2104 asking the user whether navigation unit 118 is too find a route to an address displayed in information window 2106. The user may select one of answer choices 2108 by rotating control knob 212 in a manner as previously described. If the user selects choice 2108-1, then the navigation unit 118 may calculate a route from the current location to the address displayed in information window 2106. If the user selects answer choice 2108-2, then first display 202 may present a previous display, such as, for example, the display shown in FIG. 20 or another display. If the user selects answer choice 2108-3, then the address illustrated in information window 2106 may be added to an address book of navigation unit 118. If the user selects answer choice 2108-4, then navigation unit 118 may call a telephone number displayed in information window 2106. In one embodiment, navigation unit 118 may connect to portable device 120 via short range transceiver 104 (FIG. 1) to call the telephone number displayed in information window 2106.

FIG. 22 illustrates an exemplary display of touch screen 112, which may be displayed after a user selects navigation function control 304 (FIG. 3) in some embodiments. The exemplary display may include a first layer 2202, corresponding to current function favorites 314 (FIG. 3), and a second layer 2204 corresponding to logically grouped current function menu shortcuts 316.

First layer 2202 may include a find new destination control 2206, a find nearest control 2208, and an add destination control 2210. The user may select a control of the exemplary display by touching a desired control. Selecting find new destination control 2206 may cause a display to be presented on first screen 202 or touch screen 112, through which the user may input a new destination when navigation unit 118 is not actively guiding the vehicle to a destination. Selecting find nearest control 2208 may cause a display to be presented on first screen 202 or touch screen 112, when navigation unit 118 is not actively guiding the vehicle to a destination, through which the user may be prompted for and may input a type of point-of-interest, resulting in navigation unit 118 finding a route to a nearest point-of-interest of the inputted type. Selecting add destination control 2210, when navigation unit 118 is actively guiding the vehicle to a destination, may cause a display to be presented on first screen 202 of touch screen 112, through which the user may be prompted for and may input a destination to be added to a travel itinerary.

Second layer 2204 may include a cancel route control 2212, a direction list control 2214, a detour control 2216, a voice control 2218, a map zoom control 2220 and a menu control 2222. Selection of canceled route control 2212 may cause navigation unit 118 to stop routing to a provided destination when navigation unit 118 is actively guiding the vehicle to a destination. Selection of direction list control 2214 may cause a list of directions for guiding the vehicle to the provided destination to be displayed either on first display screen 202 or touch screen 112 when navigation unit 118 is actively guiding the vehicle to a destination. Selection of detour control 2216 may cause navigation unit 118 to calculate a route that detours from a current road of travel when navigation unit 118 is actively guiding the vehicle to a destination. An updated map with new travel guidance may be displayed on first display screen 202. Selection of voice control 2218 may cause navigation unit 118 to output navigation guidance via a voice through a speaker when navigation unit 118 is actively guiding the vehicle to a destination. Selection of map zoom control 2220 may cause a displayed map to be zoomed-in (by selecting a zoom-in control 2226) or zoomed-out (by selecting a zoom-out control 2224). Selection of menu control 2222 may cause a menu to be displayed on touch screen 112.

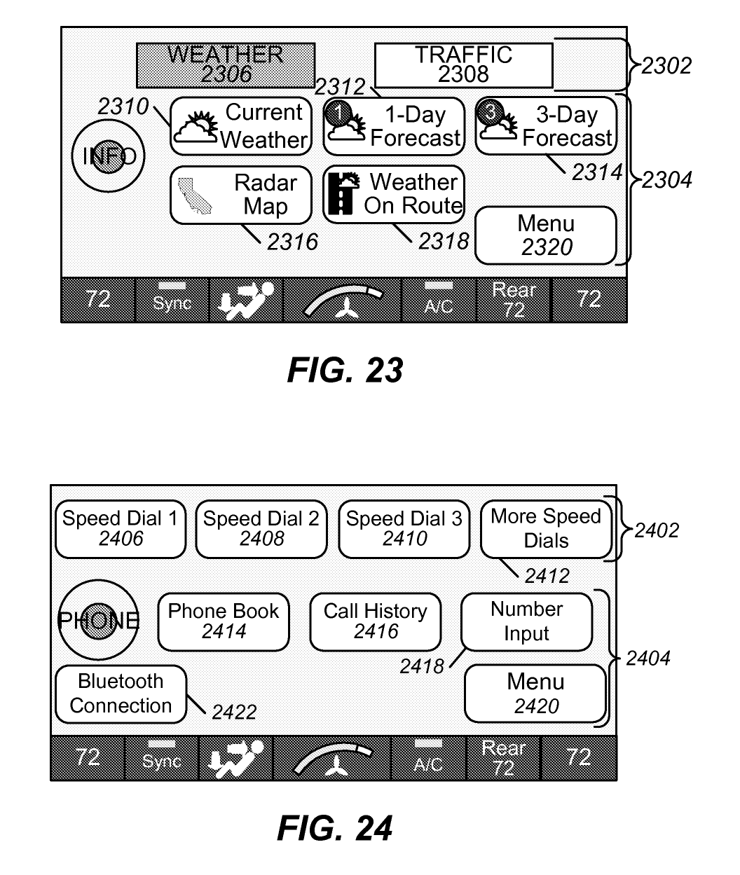

FIG. 23 illustrates an exemplary display of touch screen 112, which may be displayed after the user selects information control 306 (FIG. 3). The exemplary display may include a first layer 2302 and a second layer 2304.

First layer 2302 may correspond to current function mode, or source, controls 312 (FIG. 3) and may include a weather control 2306 and a traffic control 2308. The selection of weather control 2306 may cause a prompt to be displayed requesting input regarding a location-of-interest. Assuming that weather control 2306 is selected, after being provided with the location-of-interest, navigation unit 118 may display weather information regarding the location-of-interest on either first display screen 202 or touch screen 112. Selecting traffic control 2308 may cause navigation unit 118 to display traffic information on first display screen 202 or touch screen 112. In some embodiments, the traffic information may concern a current location. In other embodiments, the user may be prompted for a location for which traffic information is to be provided.

Second layer 2304 may correspond to logically grouped current function menu shortcuts 316 (FIG. 3) and may include a current weather control 2310, a 1-day forecast control 2312, a 3-day forecast control 2314, a radar map control 2316, a weather on route control 2318 and a menu control 2320. Selection of current weather control 2310 may cause current weather information for a current location to be displayed either on first display screen 202 or touch screen 112. Selection of 1-day forecast control 2312 may cause a 1-day forecast for the current location to be displayed either on first display screen 202 or touch screen 112. Selection of 3-day forecast control 2314 may cause a 3-day forecast for the current location to be displayed either on first display screen 202 or touch screen 112. Selection of radar map control 2316 may cause a radar map for an area including the current location to be displayed either on first display screen 202 or touch screen 112. Selection of weather on route control 2318 may cause a weather report for a current route to be displayed either on first display screen 202 or touch screen 112. Selection of menu control 2320 may cause a menu to be displayed on touch screen 112.

FIG. 24 illustrates an exemplary display of touch screen 112 or first display screen 202 after phone control 308 (FIG. 3) has been selected and before a phone call is connected or a phone number dialed. The exemplary display may include a first layer 2402, corresponding to current function favorites 314 (FIG. 3), and a second layer 2404, corresponding to logically grouped current function menu shortcuts 316 (FIG. 3).

First layer 2402 may include speed dial controls 2406, 2408, 2410 and a more speed dial control 2412. Selection of any one of speed dial controls 2406, 2408, 2410 may cause navigation unit 118 to initiate a phone call to a phone number associated with the one of the speed of controls 2406, 2408, 2410. In some embodiments, navigation unit 118 may initiate a phone call via transceiver 104 and portable device 120 (FIG. 1). Selection of more speed dial control 2412 may cause touch screen 112 or first display screen 202 to display a number of speed dial controls in a manner similar to the exemplary display of FIG. 12, with respect to station presets.

Second layer 2404 may include a phone book control 2414, a call history control 2416, a number input control 2418, a Bluetooth® connection control 2422 and a menu control 2420. Selection of phone book control 2414 may cause at least a portion of a phone book, accessible by navigation unit 118, to be displayed on touch screen 112 or first display screen 202. The user may then select one of a number of phone numbers of the phone book to which navigation unit 118 may initiate a call. Selection of call history 2416 may cause at least a portion of a call history, accessible by navigation unit 118, to be displayed on touch screen 112. The call history may include a telephone number, whether a call is an incoming call or an outgoing call, and a length of the call. Selection of number input control 2418 may cause navigation unit 118 to prompt the user for a phone number to call. Selection of Bluetooth® connection control 2422 may cause a status of a short-range connection, such as, for example, a Bluetooth® connection with a portable communication device to be displayed on first display screen 202. Selection of menu control 2420 may cause a menu to be displayed on touch screen 112 or first display 202.

In some embodiments, long lists or long input tasks may be handled via first display 202, while short/quick tasks may be handled via touch screen 112.

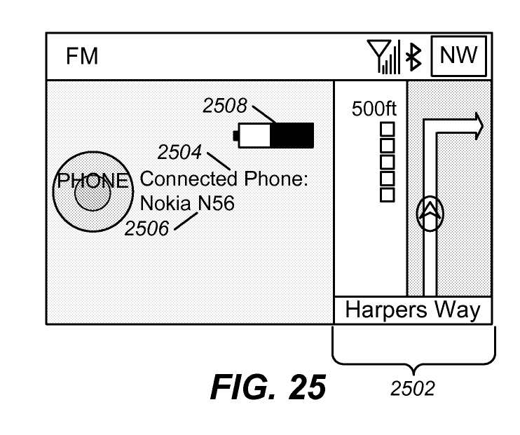

FIG. 25 illustrates an exemplary display, which may be displayed on first display screen 202 while navigation unit 118 is performing a phone function. If navigation unit 118 is currently guiding a vehicle to a destination, then turn-by-turn directions 2502 may be displayed at a navigation portion of first display screen 202, as previously described with respect to FIG. 10. The exemplary display may also present a connection status indicator 2504, phone device information 2506 and battery status information 2508.

Connection status indicator 2504 may indicate whether a communication device, such as, for example, a mobile phone, or other communication device, is wirelessly connected to navigation unit 118. Phone device information 2506 may provide information, such as, for example, a type of the phone device and a model number of the phone device. In other embodiments, phone device information 2506 may further include other information.

### Miscellaneous

In various embodiments, display screens displayed on touchscreen 112 may be displayed such that most frequently used controls may be placed closer to an operator/driver of a vehicle. In addition, controls that are used more frequently may appear in a higher position on touch screen 112 than less frequently used controls. Frequently used controls appearing on more than one display screen of touchscreen 112 may be positioned at a same location of the display screens, thereby making it easier for a user to remember a location of such controls.

### CONCLUSION

Although the subject matter has been described in language specific to structural features and/or methodological acts, it is to be understood that the subject matter in the appended claims are not necessarily limited to the specific features or acts described above. Rather, the specific features and acts described above are disclosed as example forms for implementing the claims.

Although the above descriptions may contain specific details, they are not to be con-strued as limiting the claims in any way. Other configurations of the described embodiments are part of the scope of this disclosure. Accordingly, the appended claims and their legal equivalents define the invention, rather than any specific examples given.

We claim as our invention:

1. A machine-implemented method for permitting a user to interface with a device in a vehicle, the method comprising:
presenting, to the user, a first display on a touch screen of a touch panel, the first display being layered with selectable mode controls being located at a first portion of the first display, current function favorite controls at a second portion of the first display, and HVAC indicators being located at a third portion of the first display;
presenting, to the user, a second display of a display device, the second display displaying abbreviated status information at a first portion of the second display and current function information at a second portion of the second display;
receiving input from the user based on the user touching one of the selectable mode controls or one of the current function favorite controls; and
changing the second display on the display device in response to the received input from the user.

2. The machine-implemented method of claim 1, wherein:
the user is a driver of the vehicle,
the touch panel is located in a center console area next to the driver, and
the display device is located in a center portion of a dashboard area which is easily viewable by the driver.

3. The machine-implemented method of claim 1, wherein the receiving of the input based on the user touching the one of the selectable mode controls causes a current mode to correspond to the one of the selectable mode controls.

4. The machine-implemented method of claim 1, wherein the touch panel includes presented selectable function controls, located at a fourth portion of the first display, the selectable function controls including an audio control, a navigation system control, a telephone control, and a rear entertainment system control, and
the machine-implemented method further comprises:
receiving a second input as a result of the user selecting one of the selectable function controls; and
changing the first display and the second display as a result of the receiving of the second input.

5. The machine-implemented method of claim 4, wherein the selectable function controls are hard buttons on the touch panel in close proximity to the first display.

6. The machine-implemented method of claim 4, wherein the selectable function controls further comprise an information control for requesting traffic information or weather information.

7. The machine-implemented method of claim 4, wherein:
the selectable function controls are located at a top portion of the first display,
the first portion of the first display is located at a portion of the first display below the fourth portion of the first display and above the second portion of the first display,
the second portion of the first display is located below the first portion of the first display and above the third portion of the first display, and
the third portion of the first display is located at a bottom portion of the first display.

8. The machine-implemented method of claim 4, wherein:
when the selected one of the selectable function controls is the audio control, the presented selectable mode controls comprise an AM mode control, an FM mode control, and a compact disk mode control.

9. The machine-implemented method of claim 8, further comprising:
receiving a selection of one of the AM mode control or the FM mode control; and
presenting a plurality of radio station preset controls based on the selected one of the AM mode control or the FM mode control, the plurality of radio station preset controls being the current function favorite controls.

10. The machine-implemented method of claim 1, further comprising a plurality of current function menu shortcut controls located at a fourth portion of the first display.

11. The machine-implemented method of claim 1, wherein the touch panel includes a control knob for controlling functions of the second display.

12. A system for controlling functions within a vehicle, the system comprising:
a touch panel including a touch screen located in a center console next to a seat for a driver in a vehicle;
a display device located in a central portion of a dashboard and arranged to be easily viewed by the driver; and
a computing device connected to the touch screen and the display device, the computing device including a memory having instructions for at least one processor of the computing device, the instructions comprising:
instructions for presenting abbreviated status information at a first layer of a display of the display device,
instructions for presenting current function information at a second layer of the display of the display device,
instructions for presenting a plurality of selectable mode controls at a first layer of a display of the touch screen;
instructions for presenting a plurality of logically grouped current function menu shortcut controls at a second layer of the display of the touch screen;
instructions for presenting HVAC status information at a third layer of the display of the touch screen;
instructions for receiving input based on a user touching one of the controls presented on the display of the touch screen; and
instructions for changing the display of the touch screen and the display of the display device in response to the received input.

13. The system of claim 12, wherein:
the first layer of the display of the display device is located at a top portion of the display of the display device, and
the first layer of the display of the touch screen is located at a top portion of the display of the touch screen.

14. The system of claim 12, further comprising a plurality of selectable function controls as either hard buttons in close proximity to the display of the touch screen or as selectable controls presented on the display of the touch screen, the plurality of selectable function controls comprising:
an audio control,
a navigation system control, and
a phone control.

15. The system of claim 14, wherein the instructions further comprise:
instructions for continuously displaying turn-by-turn directions on a portion of the display of the display device while the navigation system is actively guiding the vehicle to a destination.

16. The system of claim 14, wherein the plurality of selectable function controls further comprise:
an information control for requesting traffic information or weather information.

17. The system of claim 14, wherein the plurality of selectable function controls further comprise:
a rear entertainment system control.

18. The system of claim 14, wherein the instructions further comprise:
instructions for displaying the plurality of mode controls at the first layer of the display of the touch screen, which is located below the plurality of selectable function controls, when the received input indicates that a selected one of the plurality of selectable function controls is the audio control.

19. The system of claim 18, wherein the plurality of mode controls comprise an AM control, an FM control and a compact disc control.

20. The system of claim 18, wherein the instructions further comprise:
instructions for displaying a plurality of radio station preset controls at a layer of the display of the touch screen immediately below the first layer of the display of the touch screen when a second input is received indicating a selection of the FM control, the AM control, or a satellite radio control.

21. The system of claim 12, wherein the touch panel further comprises:
a control knob, and
at least one hardware button, the control knob and the at least one hardware button being arranged to be used to make a selection of one of the plurality of controls displayed on the touch screen or being arranged to be used to select an item from a list displayed on the display of the display device.
